(19) United States
(12) Patent Application Publication
(10) Pub. No.: US 2018/0075791 A1
(43) Pub. Date: Mar. 15, 2018

(54) DETECTION CIRCUIT AND DETECTION METHOD FOR DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventor: Feng LI, Beijing (CN)

(21) Appl. No.: 15/677,118

(22) Filed: Aug. 15, 2017

(30) Foreign Application Priority Data
Sep. 9, 2016 (CN) 201610815406.4

(51) Int. Cl. G09G 3/00

(52) U.S. Cl. CPC G09G 3/006; G09G 2330/12; G09G 2320/0219; G09G 2310/0213; G09G 2310/0289

(57) ABSTRACT

A detection circuit for a display device includes a source driving circuit and a gate driving circuit. The source driving circuit is configured to provide data signals for the pixel units in the display device. The gate driving circuit is configured to provide gate driving signal for the pixel units in the display device. The gate driving circuit is capable of driving the pixels units in odd number rows of the display device row by row, or the gate driving circuit is capable of driving the pixels units in even number rows of the display device row by row.

### CROSS-REFERENCE TO RELATED APPLICATIONS

The present application claims priority to Chinese Patent Application No. 201610815406.4, filed Sep. 9, 2016, and entitled “detection circuit and detection method for display device”, the entire contents of which are incorporated herein by reference.

### TECHNICAL FIELD

The present disclosure relates to the field of display technology, and more particularly to a detection circuit and a detection method for a display device.

### BACKGROUND

Before a display device goes to market, the display device is subject to a Cell Test (CT), to improve the yield. In the process of the Cell Test, the stability of the test is very important for the accuracy of the test results.

### SUMMARY

The present disclosure provides a detection circuit and a detection method for a display device.

In one aspect, there is provided a detection circuit for a display device, the display device including a plurality of data lines and a plurality of gate lines, the plurality of data lines and the plurality of gate lines intersect with each other to surround a plurality of pixel units arranged in an array, and the detection circuit including a source driving circuit and a gate driving circuit, wherein

the source driving circuit is connected with the plurality of data lines, and configured to provide data signals for the pixel units in the display device, the gate driving circuit is connected with the plurality of gate lines, and configured to provide gate driving signals for the pixel units in the display device;

the gate driving circuit includes a plurality of shift register units in cascade, each of the shift register units is configured to drive one row of pixel units, among the plurality of shift register units in cascade, an input terminal of the first shift register unit and an input terminal of the second shift register unit are respectively connected to a frame start signal terminal, an output terminal of the n^{th} shift register unit is connected to an input terminal of the (n+2)^{th} shift register unit, an output terminal of the (n+2)^{th} shift register unit is connected to a reset signal terminal of the n^{th} shift register unit, and n is an integer larger than or equal to 1; and

the gate driving circuit is capable of driving the pixels units in odd number rows of the display device row by row, or the gate driving circuit is capable of driving the pixels units in even number rows of the display device row by row.

In one embodiment, each of the pixel units in the display device includes one TFT and one pixel electrode, the TFTs in the pixel units of the rows are arranged in a Z-shaped, each of the data lines is connected respectively to pixel electrodes on the two side of the data line through the TFTs;

the source driving circuit includes a switch module, the switch module is connected respectively to a switch signal terminal, N data signal terminals and the plurality of data lines, where, N is the number of pixel units with different colors included in each pixel of the display device; and

the switch module is configured to connect the N data signal terminals correspondingly with the plurality of data lines, such that each of the data signal terminals is capable of providing data signals respectively for pixel units with the first color in odd number rows, and for pixel units with the second color in even number rows;

In one embodiment, in the gate driving circuit, an output module in the (4n−3)^{th} shift register unit is connected to a first clock signal terminal, an output module in the (4n−2)^{th} shift register unit is connected to a second clock signal terminal, an output module in the (4n−1)^{th} shift register unit is connected to a third clock signal terminal, and an output module in the 4n^{th} shift register unit is connected to a fourth clock signal terminal.

In one embodiment, the frame start signal terminal includes a first signal terminal and a second signal terminal;

the input terminal of the first shift register unit in the gate driving circuit is connected to the first signal terminal; and

the input terminal of the second shift register unit in the gate driving circuit is connected to the second signal terminal.

In one embodiment, the second shift register unit includes a pull-up holding module; and

the pull-up holding module is connected respectively to the frame start signal terminal, a first power-supply signal terminal and the pull-up node in the second shift register unit, and configured to hold a pull-up node of the second shift register unit at a first potential during the process of the gate driving circuit driving the pixel units in odd number rows of the display device row by row.

In one embodiment, the second shift register unit also includes a noise reduction module; and

the noise reduction module is connected respectively to the reset signal terminal, a second power-supply signal terminal, the pull-up holding module and a pull-down nod of the second shift register unit, and configured to reduce noise for the pull-up holding module and the pull-up nod after the second shift register unit completes driving of the second row of pixel units in the display device.

In one embodiment, the pull-up holding module includes a first transistor, a second transistor and a capacitor C;

the first transistor has a gate electrode connected to the frame start signal terminal, a first electrode connected to the first power-supply signal terminal, a second electrode connected respectively to a gate electrode of the second transistor and one end of the capacitor; and

the second transistor has a first electrode connected to the first power-supply signal terminal, a second electrode connected to the pull-up node; and

the other end of the capacitor C is connected to the pull-up node.

In one embodiment, the noise reduction module includes a third transistor and a fourth transistor;

the third transistor has a gate electrode connected to the reset signal terminal, a first electrode connected to the second power-supply signal terminal, a second electrode connected to the pull-up holding module; and

the fourth transistor has a gate electrode connected to the pull-down node in the second shift register unit, a first electrode connected to the second power-supply signal terminal, and a second electrode connected to the pull-up holding module.

In one embodiment, the switch module includes M transistors, and M is the number of data lines in the display device; and

among the M transistors, the i^{th} transistor has a gate electrode connected to the switch signal terminal, a first electrode connected to one of the N data signal terminals, a second electrode connected to one of the plurality of data lines, where i is a positive integer less than or equal to M.

In a second aspect, there is provided a detection method for a display device, applied in a detection circuit for the display device, the detection circuit including a source driving circuit and a gate driving circuit, the method including a first test phase and a second test phase, wherein

in the first test phase, the gate driving circuit drives pixel units in odd number rows of the display device, and the source driving circuit provides data signals for pixel units with a preset color in the display device, such that the pixel units with the preset color in the odd number rows are started; and

in the second test phase, the gate driving circuit drives pixel units in even number rows of the display device, and the source driving circuit provides data signals for pixel units with a preset color in the display device, such that the pixel units with the preset color in the even number rows are started.

In one embodiment, each of the pixel units in the display device includes one thin film transistor TFT and one pixel electrode, the TFTs in the pixel units are arranged in a Z shape, each of the plurality of data lines is connected respectively to pixel electrodes on the two side of the data line through the TFTs;

the source driving circuit includes a switch module, the switch module is connected respectively to a switch signal terminal, N data signal terminals and the plurality of data lines, where, N is the number of pixel units with different colors included in each pixel of the display device; and the switch module is configured to connect the N data signal terminals correspondingly with the plurality of data lines;

in the first test phase, a first data signal terminal of the N data signal terminals outputs a signal of a first potential, the other data signal terminals other than the first data signal terminal outputs a signal of a second potential, the first data signal terminal is configured to provide data signals for the pixel units with the preset color in the odd number rows of the display device; and

in the second test phase, a second data signal terminal of the N data signal terminals outputs a signal of the first potential, the other data signal terminals other than the second data signal terminal outputs a signal of the second potential, and the second data signal terminal is configured to provide data signals for the pixel units with the preset color in the even number rows of the display device.

In one embodiment, an output module in the (4n−3)^{th} shift register unit is connected to a first clock signal terminal, an output module in the (4n−2)^{th} shift register unit is connected to a second clock signal terminal, an output module in the (4n−1)^{th} shift register unit is connected to a third clock signal terminal, and an output module in the 4n^{th} shift register unit is connected to a fourth clock signal terminal;

in the first test phase, the first clock signal terminal and the third clock signal terminal output clock signals, and the second clock signal terminal and the fourth clock signal terminal output signals of the second potential, such that in the gate driving circuit, the (4n−3)^{th} shift register unit and the (4n−1)^{th} shift register unit drive the pixel units in odd number rows row by row; and

in the second test phase, the second clock signal terminal and the fourth clock signal terminal output clock signals, and the first clock signal terminal and the third clock signal terminal output signals of the second potential, such that in the gate driving circuit, the (4n−2)^{th} shift register unit and the 4n^{th} shift register unit may drive the pixel units in even number rows row by row.

In one embodiment, the frame start signal terminal includes a first signal terminal and a second signal terminal; the input terminal of the first shift register unit in the gate driving circuit is connected to the first signal terminal; and the input terminal of the second shift register unit in the gate driving circuit is connected to the second signal terminal;

in the first test phase, the first signal terminal outputs a pulse signal at the first potential, so as to charge the pull-up node of the first shift register unit;

in the second test phase, the second signal terminal outputs a pulse signal at the first potential, so as to charge the pull-up node of the second shift register unit.

In one embodiment, the second shift register unit includes a pull-up holding module, the pull-up holding module is connected respectively to the frame start signal terminal, a first power-supply signal terminal and the pull-up node in the second shift register unit;

in the first test phase, the frame start signal terminal outputs a pulse signal of the first potential, so as to charge the pull-up node in the first shift register unit, and charge the pull-up node in the second shift register unit through the pull-up holding module; and

during the first test phase, the pull-up node in the second shift register unit is held at the first potential.

In one embodiment, the first potential is at a higher level potential with respect to the second potential.

### BRIEF DESCRIPTION OF THE DRAWINGS

In order to more clearly illustrate the technical solution in the embodiments of the present disclosure, the drawings, which are intended to be used in the description of the embodiments, will be briefly described below. It will be apparent that the drawings in the following description are merely examples of the present disclosure, and other drawings may be obtained by those skilled in the art without making creative work.

FIG. 1 is a structural schematic diagram of a detection circuit for a display device in the related art;

FIG. 2 is a structural schematic diagram of a detection circuit for a display device provided by an embodiment of the present disclosure;

FIG. 3 is a structural schematic diagram of a gate driving circuit provided by an embodiment of the present disclosure;

FIG. 4 is a structural schematic diagram of another gate driving circuit provided by an embodiment of the present disclosure;

FIG. 5 is a structural schematic diagram of yet another gate driving circuit provided by an embodiment of the present disclosure; and

FIG. 6 is a structural schematic diagram of a shift register unit provided by an embodiment of the present disclosure;

FIG. 7 is a flow chart of a detection method for a display device provided by an embodiment of the present disclosure;

FIG. 8 is a time sequence diagram of a detection process for a display device provided by an embodiment of the present disclosure; and

FIG. 9 is a time sequence diagram of operation of a shift register unit provided by an embodiment of the present disclosure.

### DETAILED DESCRIPTION

In order to make the objectives, technical solutions and advantages of the present disclosure clearer, hereinafter, embodiments of the present disclosure will be further described in detail with reference to the accompanying drawings.

The transistors used in all of the embodiments of the present disclosure may be thin film transistors or filed effect tubes or devices of other characteristics. Depending on the roles in the circuit, the transistors in the embodiments of the present disclosure may mainly be switch transistors. Since for a switch transistor, the source electrode and the drain electrode are symmetric, the source electrode and the drain electrode are interchangeable. In the embodiments of the present disclosure, the source electrode is referred to as a first electrode, the drain electrode as a second electrode, and the gate electrode as a third electrode. It is prescribed that, according to the illustration in the figures, the middle terminal of the transistor is the gate electrode, the signal input terminal is the source electrode, and the signal output terminal is the drain electrode. In addition, in the embodiment of the present disclosure, the switch transistor may be any of a P-type transistor and an N-type transistor. The P-type transistor is turned on when the gate electrode is at a low level, and is turned off when the gate electrode is at a high level. The N-type transistor is turned on when the gate electrode is at a high level, and is turned off when the gate electrode is at a low level. In addition, in the embodiments of the present disclosure, many signals correspond to a first potential and a second potential. The first potential and the second potential only represent 2 states of the potentials of the signal, and do not mean that the first potential or the second potential has a particular value.

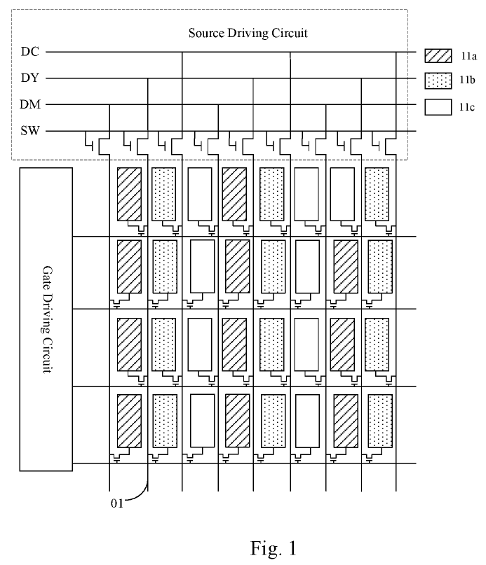

In the related art, for a display device with a chip on Glass (COG), referring to FIG. 1, the COG display device is generally driven in a Z-Inversion manner. That is, the thin film transistors (TFTs) in the pixel units in the rows of the display device are arranged in a Z-shape. Each data line in the display device is connected to the pixel electrodes at two sides of the data line through the TFTs. For example, as shown in FIG. 1, a data line 01 is connected respectively to pixel electrodes in red pixel units 11a on odd number rows on the left side, and pixel electrodes in green pixel units 11b on even number rows on the right side.

To detect such type of display device, the display device may be connected respectively to a gate driving circuit and a source driving circuit. The source driving circuit may include three data signal terminals: DC, DY and DM. Each of the three data signal terminals are connected to a corresponding one of three adjacent data lines, to provide data signals for the pixel units with different colors. For example, in the circuit as shown in FIG. 1, the data signal terminal DM may provide data signals for blue pixel units 11c in odd number rows and for red pixel units in even number rows through data lines. The data signal terminal DY may provide data signals for red pixel units in odd number rows and for green pixel units in even number rows through data lines. Therefore, when the red pixel units in the display device are subject to detect, the gate driving circuit may be caused to drive the rows of pixel units in the display device row by row. Simultaneously, the data signal terminals DY and DM in the source driving circuit may be caused to alternately output square wave signals, the data signal terminal DC may be caused to output a low level signal. When the gate driving circuit scans pixel units in odd number rows, the square wave signal outputted by the data signal terminal DY is at a high level, and the square wave signal outputted by the data signal terminal DM is at a low level. When the gate driving circuit scans pixel units in even number rows, the square wave signal outputted by the data signal terminal DY is at a low level, and the square wave signal outputted by the data signal terminal DM is at a high level. In this way, only red pixel units in the display device will be started, so that the display performance of the red pixel units can be detected.

However, the above detection method requires accurate synchronizing the cycles of the square wave signals outputted by the data signal terminals and the driving cycles of the pixel units in each row by the gate driving circuit. When there is a delay in the square wave signals outputted by the data signal terminals, it may cause the pixel units under detection in the display device cannot be started. Therefore, this detection method has a poor stability.

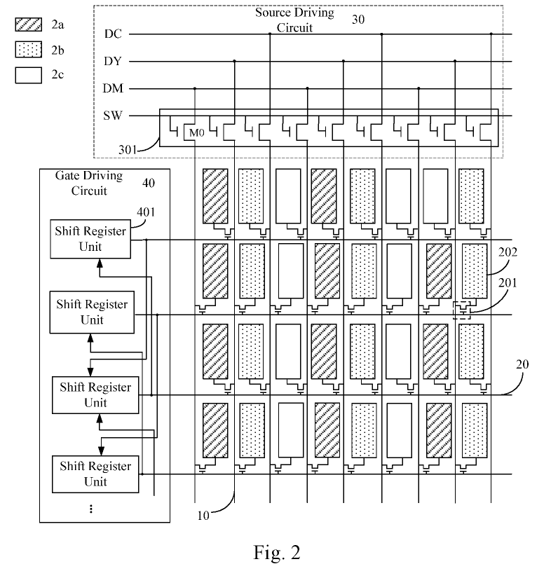

FIG. 2 is a structural schematic diagram of a detection circuit for a display device provided by an embodiment of the present disclosure. The display device includes a plurality of data lines 10 and a plurality of gate lines 20. The plurality of data lines 10 and the plurality of gate lines 20 intersect with each other to surround a plurality of pixel units arranged in an array. The detection circuit includes a source driving circuit 30 and a gate driving circuit 40.

The source driving circuit 30 is connected with the plurality of data lines 10, and configured to provide data signals for the pixel units in the display device. The gate driving circuit 40 is connected with the plurality of gate lines 20, and configured to provide gate driving signal for the pixel units in the display device.

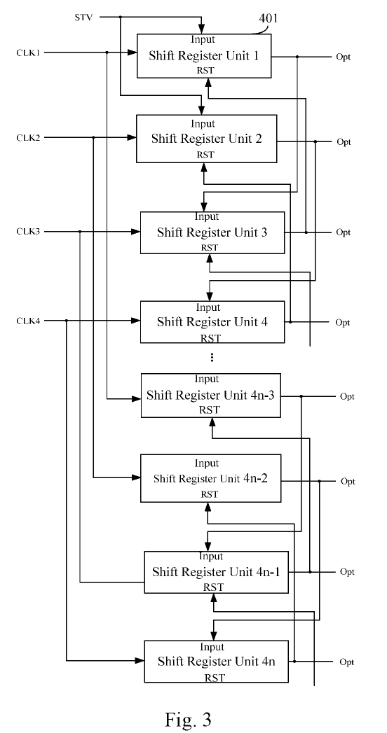

FIG. 3 is a structural schematic diagram of a gate driving circuit provided by an embodiment of the present disclosure. Referring to FIGS. 2 and 3, the gate driving circuit may include a plurality of shift register units 401 in cascade. Each of the shift register units 401 is configured to drive one row of pixel units. Among the plurality of shift register units 401 in cascade, an input terminal Input of the first shift register unit and an input terminal Input of the second shift register unit are respectively connected to a frame start signal terminal STV. An output terminal Opt of the n^{th} shift register unit is connected to an input terminal Input of the (n+2)^{th} shift register unit. An output terminal Opt of the (n+2)^{th} shift register unit is connected to a reset signal terminal RST of the n^{th} shift register unit. For example, an output terminal Opt of the shift register unit 1 is connected to an input terminal Input of the shift register unit 3. An output terminal Opt of the shift register unit 4 is connected to a reset signal terminal RST of the shift register unit 2. Wherein, n is an integer larger than or equal to 1.

The gate driving circuit 40 may drive the pixels units in odd number rows of the display device row by row. Alternatively, the gate driving circuit 40 may drive the pixels units in even number rows of the display device row by row.

According to the above, the detection circuit provided by the embodiment of the present disclosure includes a gate driving circuit and a source driving circuit. The gate driving circuit may drive the pixels units in odd number rows row by row or may drive the pixels units in even number rows row by row. Therefore, during a process of detecting pixel units with a certain color, when the gate driving circuit drives the odd number rows (or the even number rows), the data signal terminals connected to the pixel units with that color in the odd number rows (or the even number rows) may be held at a high level and do not need square wave signals outputted. In this way, it may avoid the influence on displaying pictures caused by the delay in the waveforms of the square wave signals, and improve the stability of the detection.

In one embodiment, as shown in FIG. 2, each of the pixel units in the display device includes one TFT 201 and one pixel electrode 202. The TFTs in the pixel units of the rows are arranged in a Z-shaped. That is, the display device is driven by a Z-Inversion manner. Referring to FIG. 2, each of the data lines is connected respectively to pixel electrodes on the two side of the data line through the TFTs.

The source driving circuit 30 includes a switch module 301. The switch module 301 is connected respectively to a switch signal terminal SW, N data signal terminals and the plurality of data lines 10. Where, N is the number of pixel units with different colors included in each pixel of the display device. The switch module 301 is configured to connect the N data signal terminals correspondingly with the plurality of data lines, such that each of the data signal terminals may provide data signals respectively for pixel units with the first color in odd number rows, and for pixel units with the second color in even number rows. As an example, in the display device as shown in FIG. 2, each pixel may include three pixel units with different colors: red pixel units 2a, green pixel units 2b and blue pixel units 2c. The switch module 30 in the source driving circuit 30 may include three data signal terminals DM, DY and DC. The three data signal terminals are connected respectively to the corresponding plurality of data lines. The data signal terminal DM may provide data signals respectively for the blue pixel units 2c in odd number rows and the red pixel units 2a in even number rows. The data signal terminal DY may provide data signals respectively for the red pixel units 2a in odd number rows and the green pixel units 2b in even number rows. The data signal terminal DC may provide data signals respectively for the green pixel units 2b in odd number rows and the blue pixel units 2c in even number rows.

Further, as shown in FIG. 3, the gate driving circuit may include at least 4 shift register units. An output module (not shown in the figure) in the (4n−3)^{th} shift register unit is connected to a first clock signal terminal CLK1. An output module (not shown in the figure) in the (4n−2)^{th} shift register unit is connected to a second clock signal terminal CLK2. An output module (not shown in the figure) in the (4n−1)^{th} shift register unit is connected to a third clock signal terminal CLK3. An output module (not shown in the figure) in the 4n^{th} shift register unit is connected to a fourth clock signal terminal CLK4. Each of the shift register units is provided with an output module. One end of the output module is connected to a corresponding clock signal terminal, and the other end of the output module is connected to the output terminal of that shift register unit. A gate driving signal outputted by each shift register unit is a clock signal outputted by the clock signal terminal connected to the output module of that shift register unit.

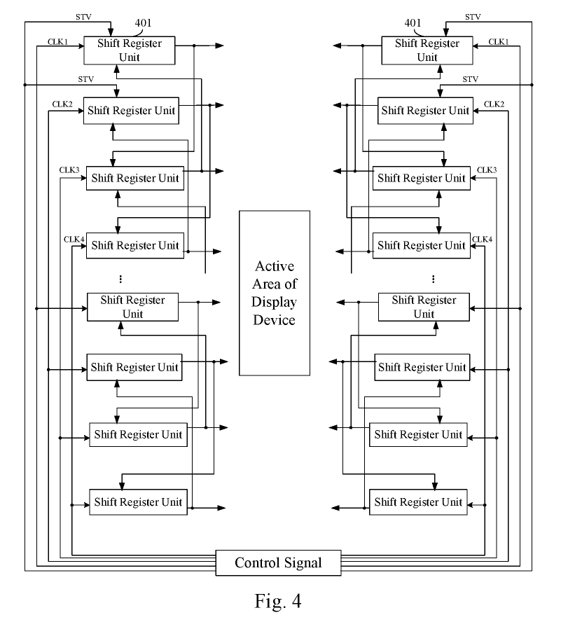

FIG. 4 is a structural schematic diagram of another gate driving circuit provided by an embodiment of the present disclosure. As shown in FIG. 4, the gate driving circuit includes two sets of shift register units. The two sets of shift register units are disposed respectively at the two sides of the active area of the display device, and may perform driving detection on the pixel units in the display device (the active area of the display device) respectively from the two ends, so as to implement the double-end driving.

In the embodiment of the present disclosure, in order to ensure that after a first test phase is finished, during a second test phase, the shift register units (i.e. the second shift register unit in the gate driving circuit) for driving the second row of pixel units may be properly turned on, a pull-up node PU in the second shift register unit is required to be held at a first potential after the first test phase is finished, otherwise the second shift register unit may not be properly turned on. In order to hold the pull-up node PU in the second shift register unit at the first potential, there are two implementations to achieve this.

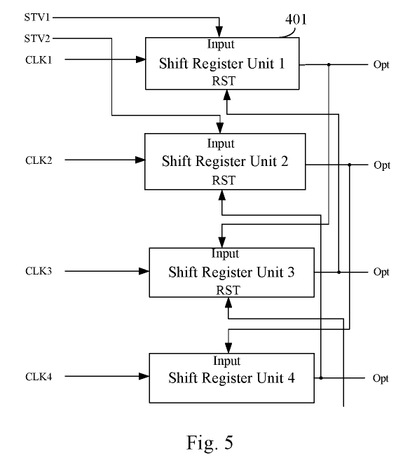

In one implementation of the present disclosure, referring to FIG. 5, the frame start signal terminal may include a first signal terminal STV1 and a second signal terminal STV2.

An input terminal Input of the first shift register unit (i.e. the shift register unit 1) in the gate driving circuit is connected to the first signal terminal STV1. An input terminal Input of the second shift register unit (i.e. the shift register unit 2) in the gate driving circuit is connected to the second signal terminal STV2. In the implementation as shown in FIG. 5, the potential of the pull-up node in the first shift register unit may be pulled up by controlling the first signal terminal STV1 to output a pulse signal at the first potential when scanning pixel units in odd number rows is started. The potential of the pull-up node in the second shift register unit may be pulled up by controlling the second signal terminal STV2 to output a pulse signal at the first potential when scanning pixel units in even number rows is started.

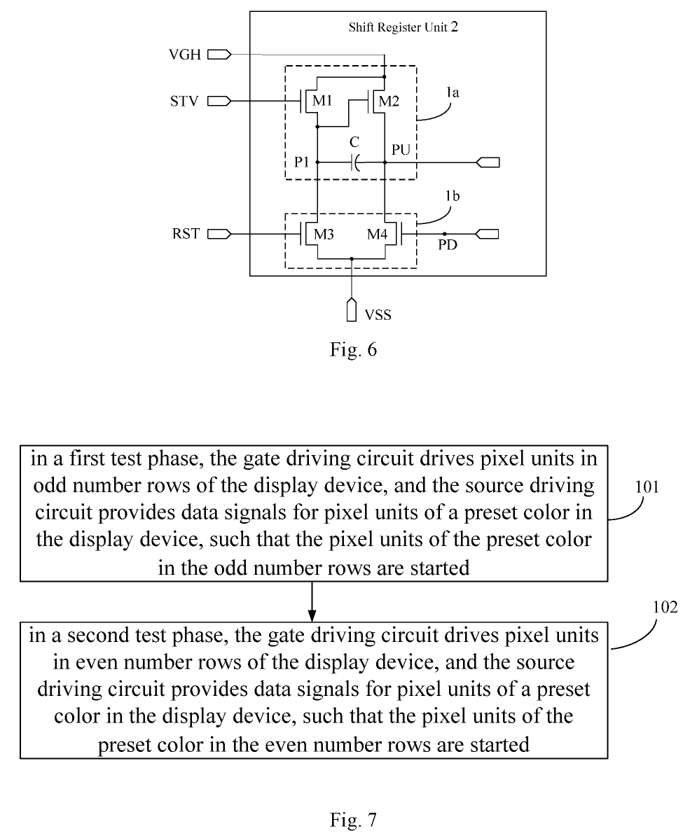

In another implementation of the present disclosure, referring to FIG. 6, the second shift register unit may also include a pull-up holding module 1a. The pull-up holding module 1a is connected respectively to the frame start signal terminal STV, a first power-supply signal terminal VGH and the pull-up node PU in the second shift register unit. The pull-up holding module 1a is configured to hold the pull-up node PU of the second shift register unit at the first potential during the process of the gate driving circuit driving the pixel units in odd number rows of the display device row by row.

Further, as shown in FIG. 6, the second shift register unit also includes a noise reduction module 1b. The noise reduction module 1b is connected respectively to the reset signal terminal RST, a second power-supply signal terminal VSS, the pull-up holding module 1a and a pull-down nod PD of the second shift register unit. The noise reduction module 1b is configured to reduce noise for the pull-up holding module 1a and the pull-up nod PU after the second shift register unit completes driving of the second row of pixel units in the display device.

Referring to FIG. 6, the pull-up holding module includes a first transistor M1, a second transistor M2 and a capacitor C. The noise reduction module includes a third transistor M3 and a fourth transistor M4.

The first transistor M1 has a gate electrode connected to the frame start signal terminal STV, a first electrode connected to the first power-supply signal terminal VGH, a second electrode connected respectively to a gate electrode of the second transistor M2 and one end of the capacitor C.

The second transistor M2 has a first electrode connected to the first power-supply signal terminal VGH and a second electrode connected to the pull-up node PU. The other end of the capacitor C is connected to the pull-up node PU.

The third transistor M3 has a gate electrode connected to the reset signal terminal RST, a first electrode connected to the second power-supply signal terminal VSS, and a second electrode connected to the pull-up holding module 1a. As shown in FIG. 6, the second electrode of the third transistor M3 is connected to the pull-up holding module 1a through a node P1.

The fourth transistor M4 has a gate electrode connected to the pull-down node PD in the second shift register unit, a first electrode connected to the second power-supply signal terminal VSS, and a second electrode connected to the pull-up holding module 1a. For example, as shown in FIG. 6, the second electrode of the fourth transistor M4 is connected to the pull-up holding module 1a through the pull-up node PU.

Further, referring to FIG. 2, the switch module 301 may include M transistors M0, and M is the number of data lines in the display device. Among the M transistors, the i^{th} transistor has a gate electrode connected to the switch signal terminal SW, a first electrode connected to one of the N data signal terminals, and a second electrode connected to one of the plurality of data lines, where i is a positive integer less than or equal to M. When the switch signal terminal SW outputs a switch signal which is at the first potential, the M transistors are all turned on, such that the N data signal terminals are conducted to the plurality of data lines.

According to the above, the detection circuit provided by the embodiment of the present disclosure includes a gate driving circuit and a source driving circuit. The gate driving circuit may drive the pixel units in odd number rows row by row or pixel units in even number rows row by row. Therefore, during the process of detecting pixel units with a certain color, when the gate driving circuit drives the odd number rows (or the even number rows), the data signal terminal connected to the pixel units with that color in the odd number rows (or the even number rows) may be held at a high level and do not need square wave signals outputted. In this way, it may avoid the influence on the displayed picture caused by the delay in the waveforms of the square wave signals, and improve the stability of the detection.

FIG. 7 is a flow chart of a detection method for a display device provided by an embodiment of the present disclosure. The method may be applied to the detection circuit of the display device as shown in any of FIGS. 2-6. The detection circuit may include a source driving circuit and a gate driving circuit. Referring to FIG. 7, the method may include the following steps.

At step 101, in a first test phase, the gate driving circuit drives pixel units in odd number rows of the display device, and the source driving circuit provides data signals for pixel units with a preset color in the display device, such that the pixel units with the preset color in the odd number rows are started.

At step 102, in a second test phase, the gate driving circuit drives pixel units in even number rows of the display device, and the source driving circuit provides data signals for pixel units with a preset color in the display device, such that the pixel units with the preset color in the even number rows are started.

According to the above, the embodiment of the present disclosure provides a detection method for a display device. In the method, when pixel units with a certain color are detected, the pixel units with that color in odd number rows and the pixel units with that color in even odd number rows may be separately tested in two test phases. Therefore, during the test, the data signal terminals connected to the pixel units with that color may be held at the first potential during one of the test phases, and held at the second potential during the other one of the test phases. The data signal terminals do not need to output square wave signals. In this way, it may avoid the influence on the displayed picture caused by the delay in the waveforms of the square wave signals, and improve the stability of the detection.

It should be noted that, in practical application, the second test phase may also be performed first, and then the first test phase is performed. That is, the pixel units in the even number rows may be driven row by row, firstly. Then, the pixel units in the odd number rows may be driven row by row. In the embodiment of the present disclosure, the order of the two test phases is not limited. In addition, with the above two test phases, it is not only possible to implement detection of the display performance of the pixel units in the display device, but also possible to observe whether the display device may properly display, so as to detection the driving performance of the gate driving circuit.

In one embodiment, as shown in FIG. 2, each of the pixel units in the display device includes one thin film transistor (TFT) and one pixel electrode. The TFTs in the pixel units are arranged in a Z shape. Each of the plurality of data lines is connected respectively to pixel electrodes on the two side of the data line through the TFTs. The source driving circuit 30 includes a switch module 301. The switch module 301 is connected respectively to a switch signal terminal SW, N data signal terminals and the plurality of data lines. Where, N is the number of pixel units included in each pixel of the display device. The switch module 301 is configured to connect the N data signal terminals correspondingly with the plurality of data lines.

In the first test phase, a first data signal terminal of the N data signal terminals outputs a signal of the first potential. The other data signal terminals other than the first data signal terminal outputs a signal of the second potential. The first data signal terminal is configured to provide data signals for the pixel units with the preset color in the odd number rows of the display device.

In the second test phase, a second data signal terminal of the N data signal terminals outputs a signal of the first potential. The other data signal terminals other than the second data signal terminal outputs a signal of the second potential. The second data signal terminal is configured to provide data signals for the pixel units with the preset color in the even number rows of the display device.

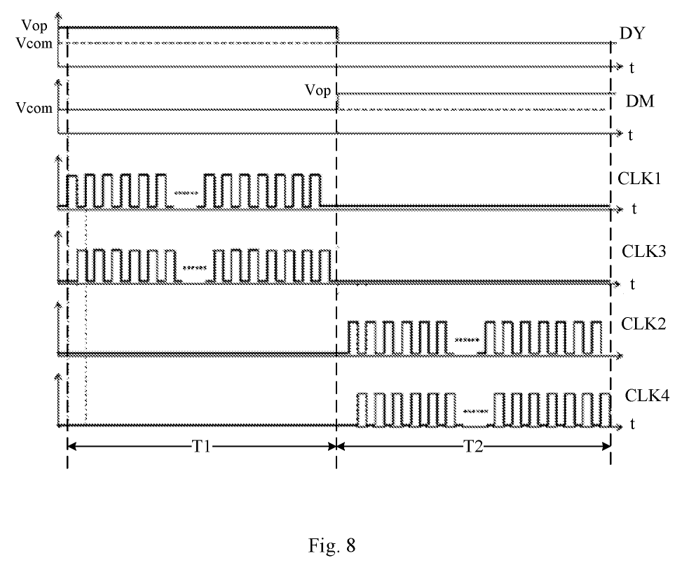

FIG. 8 is a time sequence diagram of a detection process for a display device provided by an embodiment of the present disclosure. Detection of the red pixel units in the display device is described as an example for illustration of the detection method provided by the embodiment of the present disclosure. Since the pixel units of the present color are the red pixel units, it may be seen from FIG. 2 that in the source driving circuit 30 of the detection circuit, the data signal terminal DM is configured to provide data signals for the red pixel units in the even number rows, and the data signal terminal DY is configured to provide data signals for the red pixel units in the odd number rows.

Therefore, as shown in FIG. 8, in the first test phase T1, the data signal terminal DY of the three data signal terminals outputs a signal of the first potential, the data signal terminal DM and the data signal terminal DC (not shown in FIG. 8) output signals of the second potential. Since in the first test phase, the gate driving circuit may drive and scan the pixel units in odd number rows row by row, and only the data signal terminal DY of the three data signal terminals outputs signals of the first potential, at this time, the red pixel units in odd number rows are started, and the green pixel units and the blue pixel units are in a dark state.

In the second test phase T1, as shown in FIG. 8, the data signal terminal DM of the three data signal terminals outputs signals of the first potential. For example, the voltage of the signals outputted by the data signal terminal DM may be a driving voltage Vop. The data signal terminal DY and the data signal terminal DC (not shown in FIG. 8) output signals of the second potential. For example, the voltage of the signals outputted by the data signal terminal DY and the data signal terminal DC may be a common electrode voltage Vcom. Since in the second test phase, the gate driving circuit may drive and scan the pixel units in even number rows row by row, and only the data signal terminal DM of the three data signal terminals outputs signals of the first potential, at this time, the red pixel units in even number rows are started, and the green pixel units and the blue pixel units are in a dark state. Therefore, through the above two test phases, it may implement test of the red pixel units in the display device. Moreover, during the detection process, the data signal terminal DY outputs data signals of the first potential in the first test phase, and outputs data signals of the second potential in the second test phase; the data signal terminal DM outputs data signals of the second potential in the first test phase, and outputs data signals of the first potential in the second test phase. During the detection process, the two data signal terminals do not need to output square wave signals. In this way, it may avoid the influence on the displayed picture caused by the delay in the waveforms of the square wave signals, and improve the stability of the detection.

It should be noted that, in the above two test phases, the switch signals outputted by the switch signal terminal SW are all at the first potential. At this time, the M transistors in the switch module 301 are all in the turned on state. Therefore, the N data signal terminals are conductive to the plurality of data lines, such that each data signal terminal may provide data signals to the corresponding pixel units.

It should be noted that, for a display device of a High opening rate Advanced-Super Dimensional Switching (HADS) type, due to the pixel structure corresponding to the HADS display mode, in such type display device, the data lines intersect and overlap with the common electrodes over a relatively large area, such that the coupling capacitance between the data lines and the common electrodes inside the display panel is relatively large. Therefore, the data signals transmitted by the data lines tend to be influenced by the coupling capacitance and generate delay. With the detection method in the related art, during the process that the square wave signals inputted by the data signal terminals are transmitted through the data lines, the delay in the square wave signals is large. This may result in improper display of the pixel units with the preset color. While with the detection method provided by the embodiment of the present disclosure, referring to FIG. 8, the data signal terminals in the source driving circuit do not need to output square wave signals, each of the data signal terminals may be held at the first potential or the second potential in the corresponding test phase. Therefore, it may effectively reduce the influence of the coupling capacitance on the data signals, to ensure the proper display of the pixel units to be tested in the test process, improving the stability of the detection.

It should be noted that, referring to the above method for the red pixel units, the green pixel units and the blue pixel units may be respectively tested. For example, when the green pixel units are tested, the data signal terminal DC outputs data signals of the first potential in the first test phase, and outputs data signals of the second potential in the second test phase; the data signal terminal DY outputs data signals of the second potential in the first test phase, and outputs data signals of the first potential in the second test phase; and the data signal terminal DM outputs data signals of the second potential in both of the two test phases. when the blue pixel units are tested, the data signal terminal DM outputs data signals of the first potential in the first test phase, and outputs data signals of the second potential in the second test phase; the data signal terminal DC outputs data signals of the second potential in the first test phase, and outputs data signals of the first potential in the second test phase; and the data signal terminal DY outputs data signals of the second potential in both of the two test phases.

Further, as shown in FIG. 3, an output module in the (4n−3)^{th} shift register unit is connected to a first clock signal terminal. An output module in the (4n−2)^{th} shift register unit is connected to a second clock signal terminal. An output module in the (4n−1)^{th} shift register unit is connected to a third clock signal terminal. An output module in the 4n^{th} shift register unit is connected to a fourth clock signal terminal.

Referring to FIG. 8, in the first test phase T1, the first clock signal terminal CLK1 and the third clock signal terminal CLK3 output clock signals, and the second clock signal terminal CLK2 and the fourth clock signal terminal CLK4 output signals of the second potential, such that in the gate driving circuit, the (4n−3)^{th} shift register unit and the (4n−1)^{th} shift register unit may drive the pixel units in odd number rows row by row.

In the first test phase T2, the second clock signal terminal CLK2 and the fourth clock signal terminal CLK4 output clock signals, and the first clock signal terminal CLK1 and the third clock signal terminal CLK3 output signals of the second potential, such that in the gate driving circuit, the (4n−2)^{th} shift register unit and the 4n^{th} shift register unit may drive the pixel units in even number rows row by row.

In the embodiment of the present disclosure, in order to ensure that after the first test phase is finished, during the second test phase, the shift register units (i.e. the second shift register unit in the gate driving circuit) for driving the second row of pixel units may be properly turned on, a pull-up node PU in the second shift register unit is required to be held at the first potential after the first test phase is finished, otherwise the second shift register unit may not be properly turned on. In order to hold the pull-up node PU in the second shift register unit at the first potential, there are two implementations to achieve this.

In one optional implementation, referring to FIG. 5, the frame start signal terminal may include a first signal terminal STV1 and a second signal terminal STV2. An input terminal of the first shift register unit in the gate driving circuit is connected to the first signal terminal STV1 and an input terminal of the second shift register unit in the gate driving circuit is connected to the second signal terminal STV2.

In the first test phase T1, the first signal terminal STV1 outputs a pulse signal at the first potential, so as to charge the pull-up node of the first shift register unit, such that the first shift register unit may output gate driving signals to the pixel units in the first row. At the same time, since an output terminal of the first shift register unit is connected to an input terminal of the third shift register unit, the gate driving signal outputted by the first shift register unit may charge the pull-up node in the third shift register unit, such that the third shift register unit may output gate driving signals for pixel units in the third row. The rest may be done in the same manner, to achieve the driving and scanning of the pixel units in odd number rows of the display device row by row.

In the second test phase T2, the second signal terminal STV2 outputs a pulse signal at the first potential, so as to charge the pull-up node of the second shift register unit, such that the first shift register unit may output gate driving signals to the pixel units in the second row, and also charge the pull-up node of the fourth shift register unit, to achieve the driving and scanning of the pixel units in even number rows of the display device row by row.

In another implementation, referring to FIG. 6, the second shift register unit may include a pull-up holding module 1a. The pull-up holding module 1a is connected respectively to the frame start signal terminal STV, a first power-supply signal terminal VGH and the pull-up node PU in the second shift register unit.

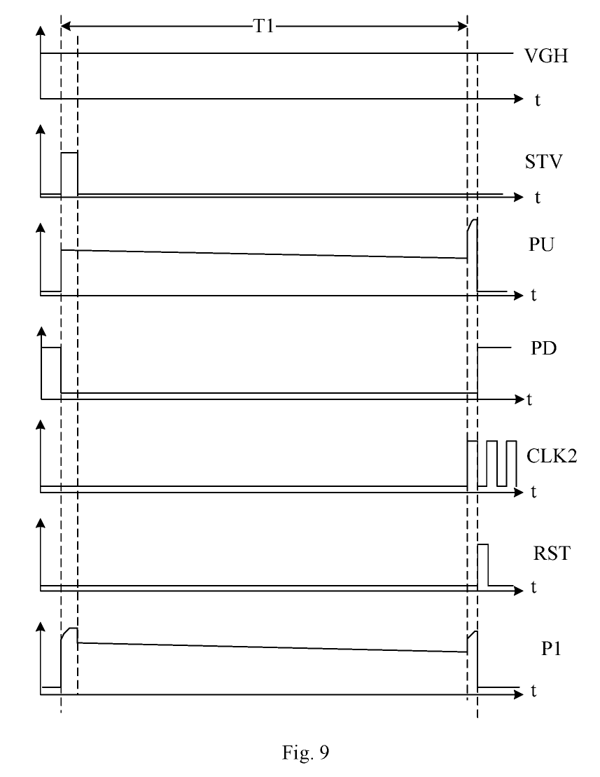

Referring to FIG. 9, in the first test phase T1, the frame start signal terminal STV outputs a pulse signal which is at the first potential, so as to charge the pull-up node in the first shift register unit, and charge the pull-up node in the second shift register unit through the pull-up holding module 1a. As shown in FIG. 9, after the frame start signal terminal STV outputs a pulse signal which is at the first potential, in the first test phase T1, the pull-up node in the second shift register unit is held at the first potential.

After the first test phase T1 is finished, the second test phase is started to be performed. At this time, referring to FIG. 8, the second clock signal terminal CLK2 and the fourth clock signal terminal CLK4 start to input clock signals. Since the output module in the second shift register unit is connected to the second clock signal terminal CLK2, when the second clock signal terminal CLK2 inputs a signal of the first potential, as shown in FIG. 9, the pull-up node PU in the second shift register unit may be further pulled up, such that the second shift register unit may output gate driving signals to the pixel units in the second rows, and further turn on the shift register units of the even number rows row by row.

Specifically, before the frame start signal terminal STV outputs a pulse signal, the pull-down node is at the first potential. The second power-supply signal terminal VSS discharge the node P1 through the fourth transistor M4 and the capacitor C. After the frame start signal terminal STV outputs a pulse signal of the first potential, the first transistor M1 is turned on, the first power-supply signal terminal VGH outputs a first power-supply signal w the first potential to the node P1. The second transistor M2 is turned on, such that the first power-supply signal terminal VGH charges the pull-up node PU.

After the pulse signal outputted by the frame start signal terminal STV jumps to the second potential, under the effect of the capacitor C, the node P1 and the pull-up node PU are held at the first potential during the first test phase T1. When the second clock signal terminal CLK2 starts to input a clock signal, the second shift register unit outputs gate driving signals to the pixels units in the second row. At the same time, the gate driving signal is taken as the input signal for the fourth shift register unit, and may charge the pull-up node of the fourth shift register unit, such that the fourth shift register unit outputs gate driving signals to the pixels units in the fourth row. Since the output terminal of the fourth shift register unit is connected to the reset signal terminal RST of the second shift register unit, referring to FIG. 9, when the reset signal inputted by the reset signal terminal RST of the second shift register unit (i.e. the gate driving signal outputted by the fourth shift register unit) is at the first potential, the third transistor M3 is turned on, and the second power-supply signal terminal outputs a second power-supply signal at the second potential to the node P1. At the same time, under the effect of the capacitor C, the potential of the pull-up node PU is pulled down to the second potential, so as to implement noise reduction for the pull-up node PU and the node P1, which may prevent improper output from the second shift register unit.

It should be noted that, in the embodiment of the present disclosure, the shift register units in the gate driving circuit may be 10T1C type. That is, each of the shift register units includes 10 transistors and 1 capacitor. The specific structure of the 10T1C type shift register unit may refer to relevant technology, which will not be repeated in the embodiment of the present disclosure.

It should be noted that, in the above embodiment, as an example for illustration, the first transistor M1, the second transistor M2, the third transistor M3 and the fourth transistor M4 are all N-type transistors, and the first potential is at a higher level potential with respect to the second potential. However, the first to fourth transistor may also be P-type transistors. When the first to fourth transistor are P-type transistors, the first potential may be a low level potential with respect to the second potential. The change in the potentials of the signal terminals and the nodes may be reverse to the potentials as shown in FIGS. 8 and 9 (the phase difference of the two cases is 180 degrees).

According to the above, the embodiment of the present disclosure provides a detection method for a display device. In the method, when pixel units with a certain color are tested, the pixel units with that color in odd number rows and the pixel units with that color in even odd number rows may be separately tested in two test phases. Therefore, during the test, the data signal terminals connected to the pixel units with that color may be held at the first potential during one of the test phases, and held at the second potential during the other one of the test phases. The data signal terminals do not need to output square wave signals. In this way, it may avoid the influence on the displayed picture caused by the delay in the waveforms of the square wave signals, and improve the stability of the detection.

The foregoing are merely preferred embodiments of the present disclosure and are not intended to limit the present disclosure. Any modifications, equivalent substitutions or alterations should be covered by the protection scope of the present disclosure.

What is claimed is:

1. A detection circuit for a display device, wherein the display device comprises a plurality of data lines and a plurality of gate lines, the plurality of data lines and the plurality of gate lines intersect with each other to surround a plurality of pixel units arranged in an array, and the detection circuit comprises a source driving circuit and a gate driving circuit,
the source driving circuit is connected with the plurality of data lines, and configured to provide data signals for the pixel units in the display device, the gate driving circuit is connected with the plurality of gate lines, and configured to provide gate driving signal for the pixel units in the display device;
the gate driving circuit comprises a plurality of shift register units in cascade, each of the shift register units is configured to drive one row of pixel units, and among the plurality of shift register units in cascade, an input terminal of a first shift register unit and an input terminal of a second shift register unit are respectively connected to a frame start signal terminal, an output terminal of a n^{th} shift register unit is connected to an input terminal of a (n+2)^{th} shift register unit, and an output terminal of the (n+2)^{th} shift register unit is connected to a reset signal terminal of the n^{th} shift register unit, where n is an integer larger than or equal to 1; and
the gate driving circuit is capable of driving the pixels units in odd number rows of the display device row by row, or the gate driving circuit is capable of driving the pixels units in even number rows of the display device row by row.

2. The detection circuit of claim 1, wherein each of the pixel units in the display device comprises a thin film transistor and a pixel electrode, each of the data lines is connected respectively to pixel electrodes on the two side of the data line through the thin film transistors;
the source driving circuit comprises a switch module, the switch module is connected respectively to a switch signal terminal, N data signal terminals and the plurality of data lines, wherein, N is the number of pixel units with different colors included in each pixel of the display device; and
the switch module is configured to connect the N data signal terminals correspondingly with the plurality of data lines, such that each of the data signal terminals is capable of providing data signals respectively for pixel units with a first color in odd number rows, and for pixel units with a second color in even number rows;

3. The detection circuit of claim 1, wherein in the gate driving circuit, an output module in the (4n−3)^{th} shift register unit is connected to a first clock signal terminal, an output module in the (4n−2)^{th} shift register unit is connected to a second clock signal terminal, an output module in the (4n−1)^{th} shift register unit is connected to a third clock signal terminal, and an output module in the 4n^{th} shift register unit is connected to a fourth clock signal terminal.

4. The detection circuit of claim 1, wherein the frame start signal terminal comprises a first signal terminal and a second signal terminal;
the input terminal of a first shift register unit in the gate driving circuit is connected to the first signal terminal; and
the input terminal of a second shift register unit in the gate driving circuit is connected to the second signal terminal.

5. The detection circuit of claim 2, wherein the frame start signal terminal comprises a first signal terminal and a second signal terminal;
the input terminal of the first shift register unit in the gate driving circuit is connected to the first signal terminal; and
the input terminal of the second shift register unit in the gate driving circuit is connected to the second signal terminal.

6. The detection circuit of claim 3, wherein the frame start signal terminal comprises a first signal terminal and a second signal terminal;
the input terminal of a first shift register unit in the gate driving circuit is connected to the first signal terminal; and
the input terminal of a second shift register unit in the gate driving circuit is connected to the second signal terminal.

7. The detection circuit of claim 1, wherein the second shift register unit comprises a pull-up holding module; and
the pull-up holding module is connected respectively to the frame start signal terminal, a first power-supply signal terminal and the pull-up node in the second shift register unit, and configured to hold a pull-up node of the second shift register unit at a first potential during the process of the gate driving circuit driving the pixel units in odd number rows of the display device row by row.

8. The detection circuit of claim 2, wherein the second shift register unit comprises a pull-up holding module; and
the pull-up holding module is connected respectively to the frame start signal terminal, a first power-supply signal terminal and the pull-up node in the second shift register unit, and configured to hold a pull-up node of the second shift register unit at a first potential during the process of the gate driving circuit driving the pixel units in odd number rows of the display device row by row.

9. The detection circuit of claim 3, wherein the second shift register unit comprises a pull-up holding module; and
the pull-up holding module is connected respectively to the frame start signal terminal, a first power-supply signal terminal and the pull-up node in the second shift register unit, and configured to hold a pull-up node of the second shift register unit at a first potential during the process of the gate driving circuit driving the pixel units in odd number rows of the display device row by row.

10. The detection circuit of claim 7, wherein the second shift register unit also comprises a noise reduction module; and
the noise reduction module is connected respectively to the reset signal terminal, a second power-supply signal terminal, the pull-up holding module and a pull-down nod of the second shift register unit, and configured to reduce noise for the pull-up holding module and the pull-up nod after the second shift register unit completes driving of a second row of pixel units in the display device.

11. The detection circuit of claim 7, wherein the pull-up holding module comprises a first transistor, a second transistor and a capacitor;
the first transistor has a gate electrode connected to the frame start signal terminal, a first electrode connected to the first power-supply signal terminal, and a second electrode connected respectively to a gate electrode of the second transistor and an end of the capacitor; and
the second transistor has a first electrode connected to the first power-supply signal terminal, and a second electrode connected to the pull-up node; and
the other end of the capacitor C is connected to the pull-up node.

12. The detection circuit of claim 10, wherein the noise reduction module comprises a third transistor and a fourth transistor;
the third transistor has a gate electrode connected to the reset signal terminal, a first electrode connected to the second power-supply signal terminal, and a second electrode connected to the pull-up holding module; and
the fourth transistor has a gate electrode connected to the pull-down node in the second shift register unit, a first electrode connected to the second power-supply signal terminal, and a second electrode connected to the pull-up holding module.

13. The detection circuit of claim 2, wherein
the switch module comprises M transistors, and M is the number of data lines in the display device; and
among the M transistors, a i^{th} transistor has a gate electrode connected to the switch signal terminal, a first electrode connected to one of the N data signal terminals, a second electrode connected to one of the plurality of data lines, where i is a positive integer less than or equal to M.

14. A detection method for a display device, applied in a detection circuit for the display device, wherein the detection circuit comprises a source driving circuit and a gate driving circuit, the gate driving circuit comprises a plurality of shift register units in cascade, each of the shift register units is configured to drive one row of pixel units, the method comprising a first test phase and a second test phase, wherein
in the first test phase, the gate driving circuit drives pixel units in odd number rows of the display device, and the source driving circuit provides data signals for pixel units with a preset color in the display device, such that the pixel units with the preset color in the odd number rows are started; and
in the second test phase, the gate driving circuit drives pixel units in even number rows of the display device, and the source driving circuit provides data signals for pixel units with a preset color in the display device, such that the pixel units with the preset color in the even number rows are started.

15. The detection method of claim 14, wherein each of the pixel units in the display device comprises a thin film transistor and a pixel electrode, the thin film transistors in the pixel units are arranged in a Z shape, each of the plurality of data lines is connected respectively to pixel electrodes on two side of the data line through the thin film transistors;
the source driving circuit comprises a switch module, the switch module is connected respectively to a switch signal terminal, N data signal terminals and the plurality of data lines, where, N is the number of pixel units with different colors included in each pixel of the display device; and the switch module is configured to connect the N data signal terminals correspondingly with the plurality of data lines;
in the first test phase, a first data signal terminal of the N data signal terminals outputs a signal of a first potential, the other data signal terminals other than the first data signal terminal outputs a signal of a second potential, the first data signal terminal is configured to provide data signals for the pixel units with the preset color in the odd number rows of the display device; and
in the second test phase, a second data signal terminal of the N data signal terminals outputs a signal of the first potential, the other data signal terminals other than the second data signal terminal outputs a signal of the second potential, and the second data signal terminal is configured to provide data signals for the pixel units with the preset color in the even number rows of the display device.

16. The detection method of claim 14, wherein an output module in the (4n−3)^{th} shift register unit is connected to a first clock signal terminal, an output module in the (4n−2)^{th} shift register unit is connected to a second clock signal terminal, an output module in the (4n−1)^{th} shift register unit is connected to a third clock signal terminal, and an output module in the 4n^{th} shift register unit is connected to a fourth clock signal terminal;
in the first test phase, the first clock signal terminal and the third clock signal terminal output clock signals, and the second clock signal terminal and the fourth clock signal terminal output signals of the second potential, such that in the gate driving circuit, the (4n−3)^{th} shift register unit and the (4n−1)^{th} shift register unit drive the pixel units in odd number rows row by row; and
in the second test phase, the second clock signal terminal and the fourth clock signal terminal output clock signals, and the first clock signal terminal and the third clock signal terminal output signals of the second potential, such that in the gate driving circuit, the (4n−2)^{th} shift register unit and the 4n^{th} shift register unit may drive the pixel units in even number rows row by row.

17. The detection method of claim 14, wherein the frame start signal terminal comprises a first signal terminal and a second signal terminal; an input terminal of a first shift register unit in the gate driving circuit is connected to the first signal terminal; and an input terminal of a second shift register unit in the gate driving circuit is connected to the second signal terminal;
in the first test phase, the first signal terminal outputs a pulse signal at the first potential, so as to charge the pull-up node of the first shift register unit; and
in the second test phase, the second signal terminal outputs a pulse signal at the first potential, so as to charge the pull-up node of the second shift register unit.

18. The detection method of claim 15, wherein the frame start signal terminal comprises a first signal terminal and a second signal terminal; the input terminal of the first shift register unit in the gate driving circuit is connected to the first signal terminal; and the input terminal of the second shift register unit in the gate driving circuit is connected to the second signal terminal;
in the first test phase, the first signal terminal outputs a pulse signal at the first potential, so as to charge the pull-up node of the first shift register unit; and
in the second test phase, the second signal terminal outputs a pulse signal at the first potential, so as to charge the pull-up node of the second shift register unit.

19. The detection method of claim 14, wherein the second shift register unit comprises a pull-up holding module, the pull-up holding module is connected respectively to the frame start signal terminal, a first power-supply signal terminal and the pull-up node in the second shift register unit;
in the first test phase, the frame start signal terminal outputs a pulse signal of the first potential, so as to charge the pull-up node in the first shift register unit, and charge the pull-up node in the second shift register unit through the pull-up holding module; and
during the first test phase, the pull-up node in the second shift register unit is held at the first potential.

20. The detection method of claim 15, wherein the first potential is at a higher level potential with respect to the second potential.
